(19) United States
(12) Patent Application Publication
(10) Pub. No.: US 2013/0248315 A1
(43) Pub. Date: Sep. 26, 2013

(54) ROTATING PART FOR IMAGE FORMING APPARATUS, CARTRIDGE FOR FORMING IMAGE, AND IMAGE FORMING APPARATUS

(71) Applicant: MITSUBISHI CHEMICAL CORPORATION, Tokyo (JP)

(72) Inventors: Shinichi IIJIMA, Jurong (SG); Shuichi Ikeda, Kanagawa (JP); Makoto Furuune, Kanagawa (JP)

(73) Assignee: MITSUBISHI CHEMICAL CORPORATION, Tokyo (JP)

(21) Appl. No.: 13/837,171

(22) Filed: Mar. 15, 2013

Related U.S. Application Data
(60) Provisional application No. 61/615,012, filed on Mar. 23, 2012.
(60) Provisional application No. 61/648,488, filed on May 17, 2012.

(51) Int. Cl. F16D 41/00

(52) U.S. Cl. CPC F16D 41/00
USPC 192/46

(57) ABSTRACT

A rotating part for an image forming apparatus, including: a drive member; and a driven member, wherein either of the drive member and the driven member has a male part formed in the direction of a rotational shaft, wherein the other of the drive member and the driven member has a female part formed in the direction of the rotational shaft, and wherein the male part is a ratchet-shape male part to be inserted into the female part and in which when the drive member rotates in a first direction, the male part is brought into engagement with the female part to thereby transmit power from the drive member to the driven member, while when the drive member rotates in a second direction opposite to the first direction, the male part and the female part move away from each other to thereby transmit no power.

### TECHNICAL FIELD

The invention relates to a rotating part provided in an image forming apparatus, a cartridge for forming an image having the rotating part, and an image forming apparatus equipped with the rotating part and the cartridge.

### BACKGROUND ART

A hitherto-known image forming apparatus has an organic photo conductor (OPC) drum and a columnar rotating body. Such an image forming apparatus is used as a laser printer, an LED printer, a printer analogous to these printers, a facsimile machine, or a multifunctional document processor including a printer function.

As shown in FIGS. 9 and 10, in such an image forming apparatus, a process cartridge 2 is removably attached to a main body, wherein the cartridge 2 has electrifying means, developing means or cleaning means, and an OPC-type photosensitive drum (hereinbelow referred to as an “OPC drum”). The image forming apparatus is further equipped with a rotating part that functions as a power transmission mechanism for rotating the OPC drum in the process cartridge 2 by means of power output from a drive source of the main body when the process cartridge 2 is loaded into the main body.

The rotating part is made up of a drive shaft that rotates integrally along with the drive source of the main body and a drum shaft for rotating the OPC drum. Indentations (female parts) and protrusions or projections (male parts) are formed in each of the drive shaft and the drum shaft. The indentations and the projections are engaged with each other, whereby drive force (rotating force) is transmitted from the drive shaft to the drum shaft.

The indentations and the projections are formed so as to assume a polygonal shape, like a triangular shape and a hexagonal shape, in order to hinder loading of an incompatible process cartridge.

### CITATION LIST

### Patent Document

[Patent Document 1] Specifications of U.S. Pat. No. 5,903,803

### SUMMARY OF INVENTION

### Technical Problem

In the related-art rotating part that is described in connection with Patent Document 1 and that has a twisted hole and a twisted columnar protrusion corresponding to the twisted hole, rotation must be given in agreement with a twist of the columnar protrusion when the twisted columnar protrusion is formed by injection molding, and a molding die tends to become structurally complicated and large. Also, it is difficult to fabricate a molding die that can simultaneously mold a plurality of end members having the twisted columnar protrusions.

Further, according to the technique described in connection with Patent Document 1, on the occasion of unloading the process cartridge from an apparatus main body, rotation must be given in a direction opposite to a driving direction when the twisted columnar protrusion serving as a shaft bearing part is disengaged from the twisted hole of the drive shaft. This sometimes hinders performance of smooth disengagement.

In addition, it cannot be said that the shaft bearing part with the columnar protrusion, such as that described in connection with Patent Document 1, sufficiently smoothly enables removal engagement of the apparatus main body from the drive shaft while maintaining sufficient transmission accuracy of rotation. For instance, without a superior configuration relationship between the hole of the drive shaft and the shaft bearing part, drive force is not appropriately transmitted, or an area of a contact region between the hole and the shaft bearing part becomes smaller, which often causes a problem of flaws or dents being caused by concentration of forces.

Accordingly, in light of the problems, the invention aims at providing a rotating part that enables smooth removal loading of a photosensitive drum to an apparatus main body while sufficiently transmitting rotational drive force and that also exhibits superior productivity.

### Solution to Problem

It is therefore an aspect of the invention to provide a rotating part for an image forming apparatus including:

a drive member which transmits power; and

a driven member which is rotated by the drive member, wherein

either of the drive member and the driven member has a male part which is formed in the direction of a rotational shaft, wherein

the other of the drive member and the driven member has a female part which is formed in the direction of the rotational shaft and into which the male part is inserted, and wherein

the male part is a ratchet-shape male part that is configured so as to be inserted into the female part and in which when the drive member rotates in a first direction, the male part is brought into engagement with the female part to thereby transmit power from the drive member to the driven member, while when the drive member rotates in a second direction opposite to the first direction, the male part and the female part move away from each other in the direction of the rotational shaft to thereby transmit no power from the drive member to the driven member.

The female part may be a twisted triangular female part in which a section normal to the rotational shaft has a triangular shape and the triangular shape of the section continuously rotates about the rotational shaft from a bottom portion to a top portion whereby a predetermined difference in angle about the rotational shaft is provided between a triangular shape which forms a section at the base portion and a triangle which forms a section at the top portion.

The ratchet-shape male part may include a plurality of wedges extending from a surface of a bottom surface.

A side profile of the wedges may be triangular, and the side profile of the wedges may be right triangular.

The side profile of the wedges may be obtuse triangular, or the side profile of the wedges may be quadrilateral.

The wedge may have an inner side profile and an outer side profile which correspond to an interior radial position and an exterior radial position, respectively, of the rotating part, wherein

the inner side profile and the outer side profile may have different shapes, and wherein

the inner side profile may be larger than the outer side profile.

The wedges each may include a contact surface which extends between corresponding edges of the inner and outer side profiles thereof which have quadrilateral shapes, the contact surface configured to have a complementary contour to that of a corresponding contact surface of the twisted triangular female part.

A side profile from an outer radial view of the wedges may differ from an inner radial view of the wedges, with respect to a radial direction extending from a rotation direction of the rotating part.

The rotating part may further include a cylindrical body including a photoconductor.

An imaging cartridge for an image forming apparatus according to one aspect of the invention includes the above mentioned rotating part.

An image forming apparatus according to one aspect of the invention includes the above mentioned imaging cartridge and the twisted triangular female part as a drive member for driving and rotating the rotating part.

An image forming apparatus according to another aspect of the invention includes:

a rotating part removable from the image forming apparatus, the rotating part including a twisted triangular female part; and

a drive transmission member including a ratchet-shape male part configured to be inserted into the twisted triangular female part to drive and rotate the rotating part.

The female part may be a female part having a prism-like shape, and wherein

the male part may include a plurality of ratchet-shape male parts configured to be inserted into the prism-shaped female part and each of the ratchet-shape male part may have a rotational force receiving surface which is brought into contact with an inner circumferential surface of the female part.

In the ratchet-shape male parts, a back surface of the rotational force receiving surface may be a curved slope.

In the ratchet-shape male parts, an inner circumferential surface which faces oppositely the rotational shaft may be formed into an arc-like shape which is arcuate about the rotational shaft.

By means of such a configuration, in the rotating part used in the image forming apparatus, the shape of the engagement portion between the drive member and the driven member can be optimized. In addition, the male part and the female part are not necessary to have shapes directly corresponding to each other. Furthermore, it is possible to inhibit engagement portion from undergoing deformation or to hinder loading of an incompatible process cartridge. Moreover, by configuring the male parts as the ratchets, when compared with conventional male parts, the material needed to form the male parts can be reduced largely.

### Advantage of the Invention

According to the rotating part of the invention, in the rotating part used in the image forming apparatus, the shape of the engagement portion between the drive member and the driven member can be optimized,

### BRIEF DESCRIPTION OF THE DRAWINGS

FIG. 1 is a schematic view explaining the engagement between a first ratchet-shape male part according to the first embodiment and a twisted triangular female part.

FIG. 2 is a schematic view explaining the engagement between a second ratchet-shape male part according to the first embodiment and a twisted triangular female part.

FIG. 3A is a perspective view of a gear mechanism having a hexagonal male part disclosed in U.S. Provisional Application No. 61/614,346, and FIG. 3B is a plan view of the gear mechanism.

FIG. 4 is a top view of a gear mechanism having a ratchet-shape male part according to the second embodiment.

FIG. 5 is a cross sectional view taken along line N-N shown in FIG. 4.

FIG. 6 is a side elevation of the gear mechanism having a ratchet-shape male part according to the second embodiment.

FIG. 7 is a side perspective view of the gear mechanism having a ratchet-shape male part according to the second embodiment.

FIG. 8 is a top perspective view of the gear mechanism having a ratchet-shape male part according to the second embodiment.

FIG. 9 is a schematic view showing exemplarily an image forming apparatus.

FIG. 10 is a schematic view showing exemplarily the configuration of a process cartridge.

FIG. 11 is a perspective view depicting an external appearance of a photosensitive drum unit.

### DETAILED DESCRIPTION OF EMBODIMENTS

Rotating parts of embodiments of the invention are hereunder described by reference to the drawings.

### First Embodiment

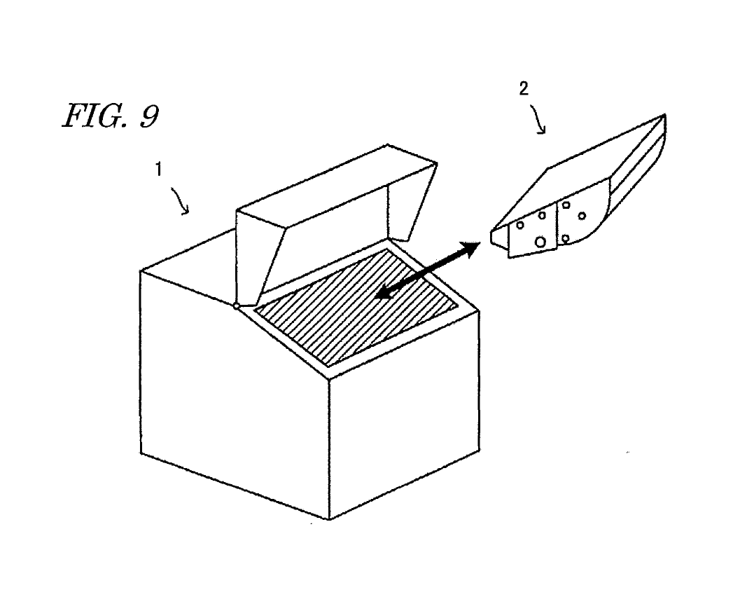

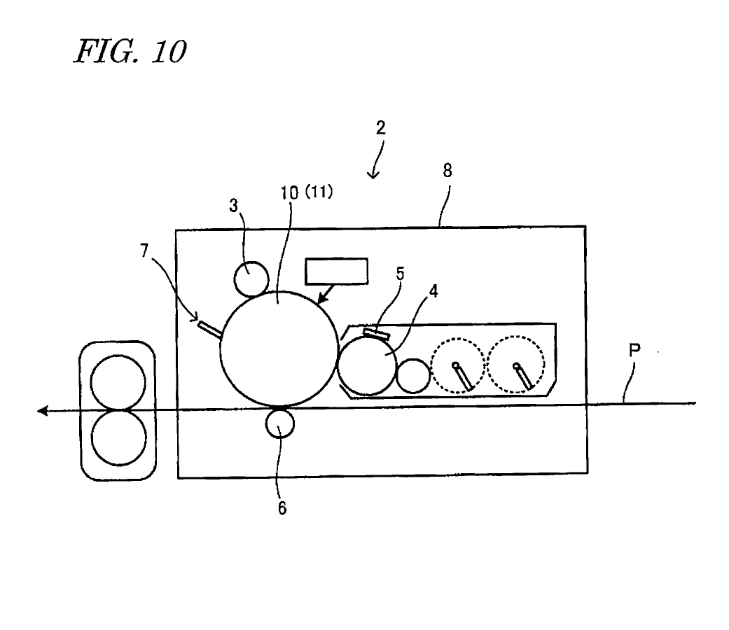

A drive shaft 20 of an embodiment makes up a portion of a rotating part and is used in; for instance, a process cartridge 2 having a photosensitive drum unit 10 shown in FIG. 10. The process cartridge 2 is removably fitted into an image forming apparatus main body 1 shown in FIG. 9. When the process cartridge 2 is loaded into an image forming apparatus, the image forming apparatus functions as; for instance, a laser printer, a copier, a facsimile machine, and the like.

The process cartridge 2 has a housing 8 that makes up a contour of the process cartridge, and various parts are encapsulated in the housing 8. Specifically, in the embodiment, the housing 8 has the photosensitive drum unit 10, an electrifying roller 3, a developing roller 4, a regulatory part 5, transfer means 6, and a cleaning blade 7. As a result of a medium, like paper, travels through an inside of the process cartridge 2 along a line designated by P shown in FIG. 10, whereby an image is formed on the medium.

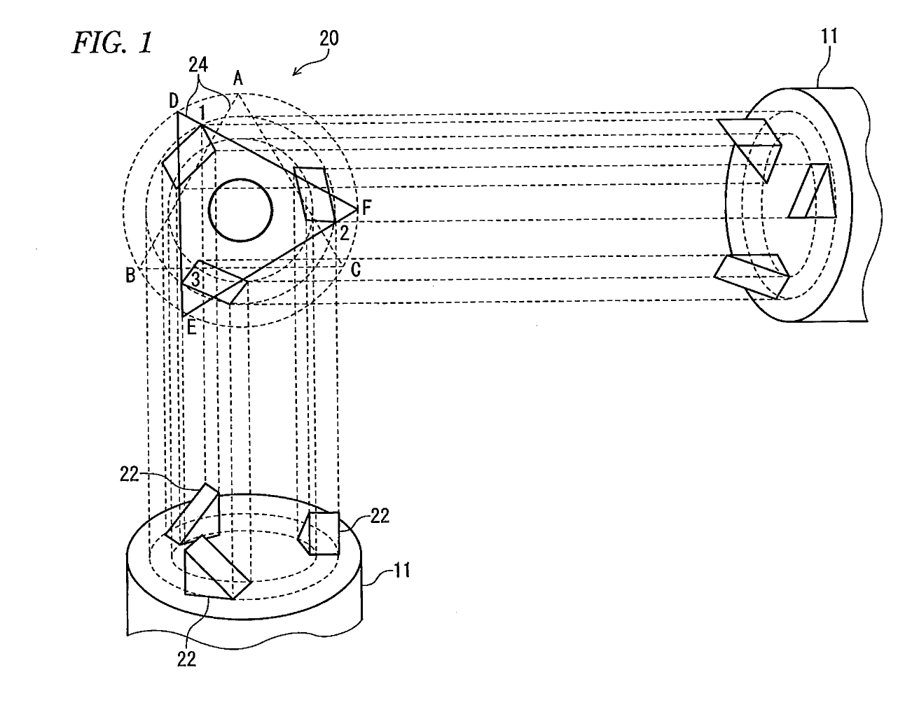

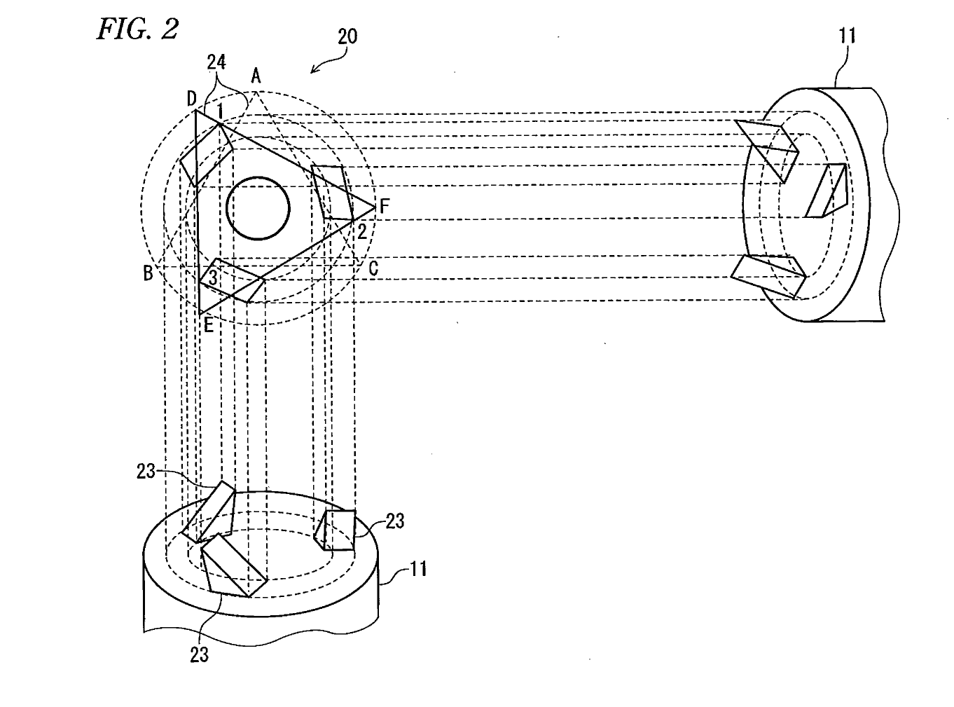

Moreover, removal fitting of the process cartridge 2 into the apparatus main body 1 is carried out in substantially the following manner. The photosensitive drum unit 10 provided in the process cartridge 2 rotates upon receipt of rotational drive force from the apparatus main body 1. Consequently, at least at the time of operation, the drive shaft 20 of the apparatus main body 1 and a ratchet-shape male part 22 or 23 (See FIGS. 1 and 2) of the photosensitive drum unit 10 that makes up a shaft bearing part must remain in engagement with each other. In the meantime, at the time of removal fitting of the process cartridge 2 into the apparatus main body 1, the drive shaft 20 of the apparatus main body 1 must be out of engagement with the ratchet-shape male part 22 or 23 of the photosensitive drum unit 10.

Accordingly, the drive shaft 20 of the apparatus main body 1 is configured so as to be able to move along its axial direction. At the time of removal fitting of the process cartridge 2, the drive shaft 20 stands disengaged from the ratchet-shape male part 22 or 23 of the photosensitive drum unit 10. In the meantime, after the process cartridge 2 is loaded into the apparatus main body 1, the drive shaft 20 is moved into engagement with the ratchet-shape male part 22 or 23 of the photosensitive drum unit 10.

As above, it is preferable that the drive shaft 20 of the apparatus main body 1 and the ratchet-shape male part 22 or 23 of the photosensitive drum unit 10 should transmit adequate rotational drive force and smoothly enter into engagement with or come out of engagement from each other.

The configuration of respective parts of the image forming apparatus is hereinbelow described.

As mentioned above, the process cartridge 2 is equipped with the electrifying roller 3, the developing roller 4, the regulatory part 5, the cleaning blade 7, and the photosensitive drum unit 10. Each of them is configured as follows.

The electrifying roller 3 electrifies an OPC drum 11 of the photosensitive drum unit 10 by application of a voltage from the image forming apparatus main body 1. This is carried out when the electrifying roller 3 rotates while following the OPC drum 11 and comes into contact with an outer peripheral surface of the OPC drum 11.

The developing roller 4 is a roller that feeds developing powder to the OPC drum 11. The developing roller 4 develops an electrostatic latent image created on the OPC drum 11. A stationary magnet is housed in the developing roller 4.

The regulatory part 5 is one that adjusts an amount of developing powder to adhere to the outer peripheral surface of the developing roller 4 and that imparts frictional electrifying charges to the developing powder. The cleaning blade 7 is a blade that contacts the outer peripheral surface of the OPC drum 11 and eliminates the developing powder still remaining on the outer peripheral surface with a leading end of the blade after transfer.

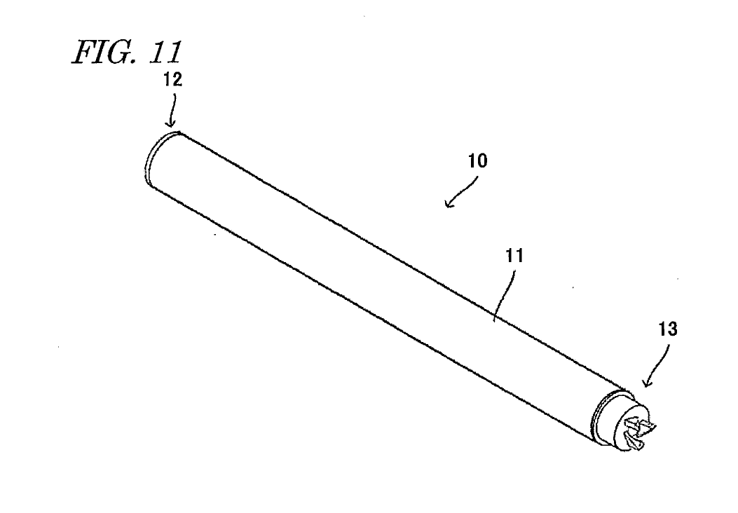

The photosensitive drum unit 10 has the OPC drum 11, and characters, pictures, and the like, to be transferred to a recording medium are created on the OPC drum 11. FIG. 11 shows an external perspective view of the photosensitive drum unit 10. As can be seen from FIG. 11, the photosensitive drum unit 10 has the OPC drum 11, a cap member 12, and an end part 13.

The OPC drum 11 is a part made by covering an outer peripheral surface of a cylindrical base substance with a photosensitive layer. Characters, pictures, and others, to be transferred onto a recording medium, like paper, are created on the photosensitive layer.

The base substance is cylindrically formed from a conductive material, like aluminum or an aluminum alloy. Specific limitations are not imposed on the type of aluminum alloy used for the base substance. However, it is preferable that the aluminum alloy should be any of 6000-series, 5000-series, or 3000-series aluminum alloys which are set by the JIS standards and often used as a base substance of a photosensitive drum.

Moreover, the photosensitive layer formed over the outer peripheral surface of the base substance is not particularly limited. A known photosensitive layer can be applied for any purpose.

The base substance can be manufactured by formation of a cylindrical shape through the use of cutting, extrusion, drawing, or the like. The OPC drum 11 can be manufactured by applying in layers a photosensitive layer over the outer peripheral surface of the base substance.

The end part 13 is attached to one end of the OPC drum 11, and the cap member 12 is placed on the other end of the same.

The cap member 12 is one made of a resin and includes a coaxial combination of a fitting part to be fitted to a cylindrical inside of the OPC drum 11 and a shaft bearing part placed so as to cover one end face of the OPC drum 11. The shaft bearing part has an area that assumes a disk shape covering the end face of the OPC drum 11 and that receives a shaft. The cap member 12 is provided with an earth plate made of a conductive material and thereby electrically connects the OPC drum 11 to the apparatus main body 1.

Although the embodiment describes an example of the cap member, the cap member is not restricted to the example. A cap member having another form that is commonly assumed is also applicable. For instance, the cap member can also have cogs for transmitting rotational force. In addition, the conductive material can also be provided on a side of the end part 13.

Another configuration is also available, wherein a conducting plate (an earth plate) is provided on the side of the end part 13 having the ratchet-shape male part 22 or 23 and wherein the conducting plate is brought into contact with an electrode provided on a side of the apparatus main body 1 close to the drive shaft 20, thereby bringing the OPC drum 11 into electrical conduction. On that occasion, there can be mentioned a technique for forming the ratchet-shape male part 22 or 23 itself from a conductive material, a technique for making the conducting plate exposed to an inner periphery of the ratchet-shape male part 22 or 23, and the like.

Manipulation and operation of the above-described image forming apparatus are now described.

In relation to fitting of the process cartridge 2 into the apparatus main body 1, the process cartridge 2 is loaded into the apparatus main body 1 along a predetermined guide as shown in FIG. 9. The drive shaft 20 of the apparatus main body 1, at this time, stands receded from a trajectory of movement of the process cartridge 2.

After the process cartridge 2 is housed in a predetermined location of the apparatus main body 1, the drive shaft 20 moves toward the process cartridge 2 in synchronism with operation for closing the cap of the main body 1 or by means of another operation, whereupon the ratchet-shape male part 22 or 23 is fitted into a twisted triangular female part 24, which makes up a recess formed in the drive shaft 20, so that both the male part 22 or 23 and the female part 24 are coaxially engaged. Rotational drive force is thereby transmitted from the apparatus main body 1 to the ratchet-shape male part 22 or 23, the end part 13, and the OPC drum 11 so that the OPC drum 11 can rotate around an axis synchronously. Further, the rotational drive force originating from the apparatus main body 1 is also transmitted to another constituent part (e.g., electrifying means 4) provided in the process cartridge 2 directly or by way of another part, so that the other constituent part also becomes rotatable.

The image forming apparatus is activated while the process cartridge 2 is loaded and while the OPC drum 11, and the like, stands rotatable. When desired characters and drawings are represented on the recording medium, rotational drive force is imparted from the apparatus main body 1, whereupon the photosensitive drum unit 10 rotates and the OPC drum 11 is electrified by the electrifying roller 3.

The OPC drum 11 is exposed to a laser beam corresponding to image information by use of unillustrated various optical members while the photosensitive drum unit 10 is in the course of rotation, thereby creating an electrostatic latent image based on the image information. The latent image is developed by the developing roller 4.

In the meantime, the recording medium, like paper, is set to another area of the apparatus main body 1, conveyed to a transfer position by means of feed rollers, conveyor rollers, and other rollers provided in the apparatus main body 1, and moved along an arrow shown in FIG. 10. The transfer means 6 is placed at the transfer position. A voltage is applied to the transfer means 6 along with passage of the recording medium, whereby the image is transferred from the OPC drum 11 to the recording medium. Subsequently, the recording medium is subjected to heat and pressure, whereby the image is fixed on the recording medium. The recording medium on which the image is created is output from the apparatus main body 1 by means of output rollers, or the like.

As to the OPC drum 11, the cleaning blade 7 contacts the outer peripheral surface of the OPC drum 11 to eliminate, with its leading end, the developing powder, which is still left on the surface after transfer, in preparation for the next image. The developing powder scraped by the cleaning blade 7 is output as publicly known.

In view of manipulation and operation of the image forming apparatus, there are many opportunities to removably attach the process cartridge. At the occasion of operation of the image forming apparatus 1, the OPC drum 11 is understood to undergo heavy load resultant of repeated rotation and suspension and also experiences harsh conditions, electrification, and heating. In addition to exhibiting the fundamental function, like appropriate transmission of rotational drive force, by means of the aforementioned form of the ratchet-shape male part 22 or 23, the invention enables assurance of sufficient accuracy in rotation by means of the contour of the ratchet-shape male part 22 or 23. Moreover, the ratchet-shape male part 22 or 23 does not have any twisted shape or an undercut and, hence, removable attachment of the twisted triangular female part 24 to the ratchet-shape male part 22 or 23 is also easy.

In light of production of the ratchet-shape male part 22 or 23, since the male part 22 or 23 has neither the twisted shape nor the undercut, filling a die assembly with a material and easy removal of molded products from the die assembly can be enhanced, so that productivity can be improved. Further, mechanisms for rotating slide cores and dies become obviated, so that a configuration of the molding die can be simplified.

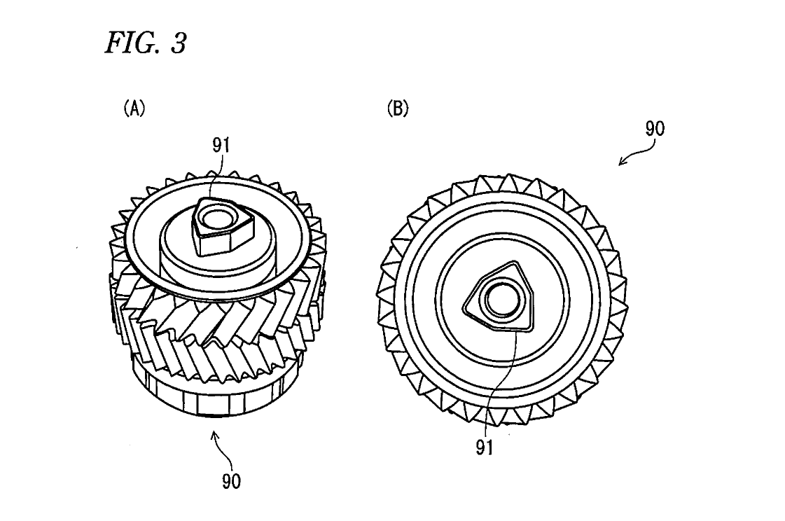

Case 6 of U.S. Provisional Patent Application No. 61/614,346 discloses a rotating part which is used in the process cartridge described above. In this rotating part, as shown in FIGS. 3A and 3B, a male part 91 is formed on a gear mechanism 90 for engagement with an OPC drum 11. This male part 91 is made up of a prism having a hexagonal cross section. By being inserted into a twisted triangular female part, the male part 91 engages with the female part, whereby a driving force is transmitted thereto from a gear mechanism 90 to the OPC drum 11.

In contrast to this, in the first embodiment of the invention, as shown in FIGS. 1 and 2 as Cases 1 and 2, the ratchet-shape male parts (that is, the circular row of wedge-like protrusions) 22, 23 engages with the twisted triangular female part (that is, the recessed portion) 24 in an ensured fashion to transmit the rotational driving force between the drive member and the driven member.

Each of the ratchet-shape male part 22, 23 and the twisted triangular female part 24 shown in FIGS. 1 and 2 can be utilized as a drive or driven components. That is, taking an OPC drum 11 as an example, the OPC drum 11 may be provided with a ratchet-shape male part 22 or 23, where the drive member is provided with the twisted triangular female part 24. On the other hand, the OPC drum 11 may be provided with the twisted triangular female part 24, where the drive member is provided with the ratchet-shape male part 22 or 23.

When a ratchet-shape male part 23 rotates in a desired forward direction (a first direction) by a gear mechanism, not shown, the ratchet-shape male part 23 come into engagement with the twisted triangular female part 24, whereby the rotational driving force is transmitted from the gear mechanism to the OPC drum 11. On the other hand, when the gear mechanism rotates in an opposite direction (in a second direction), the ratchet-shape male part 23 and the twisted triangular female part 24 move away from each other in the direction of a rotational shaft so that no rotational driving force is transmitted from the gear mechanism to the OPC drum 11.

In a further embodiment, the female part may not be twisted. In certain embodiments shown and/or not shown in the figures, first edges of the wedges of the ratchet-shape male part 22 or 23, which extend in an axial direction (that is, edges extending more-or-less directly towards the female part), are straight and perpendicular to a surface of the end of the OPC drum 11. Here, the surface of the end of the OPC drum 11 is perpendicular to the rotational axis of the OPC drum 11. In another embodiment, these first edges have an angle with respect to the surface of the end of the OPC drum 11 and perpendicular with the surface of the end of the OPC drum 11 so that the first edges are not perpendicular to the surface of the end of the OPC drum 11. Thus, in this embodiment, the wedges from acute or obtuse triangular shapes when viewed from the side (a side profile), whereas, in the prior discussed embodiment, the wedges form right triangles.

In further aspects of these embodiments, the triangular shape formed by the wedges, when viewed from the side, have two edges which are the same length, preferably being the two edges other than the hypotenuse or the longest (third) edge of the triangular shape. Also, the intersections of these edges and/or the edges themselves are rounded in some embodiments (not shown). These and other effects/features will be appreciated in light of the following discussion concerning the examples shown in the drawings.

FIG. 1 illustrates a twisted triangular female part 24 as including a shape which twists from triangle DEF to triangle ABC from an insertion perspective in Case 1. That is, triangle ABC is, in some aspects, at a base on the female part/recess, whereas triangle DEF is, in some aspects, at an open-end face of the female part/recess. The ratchet-shape male part 22 of Case 1 contacts the twisted triangular female part 24 at points 1, 2 and 3, thus providing a mechanism for driving.

Although the edges of the male and female parts are shown as being straight and coming to points in FIG. 1, the various contact points, in other aspects, can be rounded and/or the edges include curves.

Also, the various contact points can also include protrusions consistent with Case 7 of the provisional application U.S. 61/614,346 filed Mar. 22, 2012, where the contact edges of the wedges of the ratchet-shape male part include protrusions which can be dented when engaging a corresponding contact point of the twisted triangular female part 24, providing a strong connection to an edge/contact point of the corresponding twisted triangular female part 24.

In this case, the dent serve as gear teeth which mesh with the edges/contact points of the corresponding twisted triangular female part 24. These protrusions are formed parallel to the inserting direction (the direction of the rotational shaft) near the contact points of the male parts. Additionally, the protrusions are formed from a polymer having flexibility, and when the male parts are inserted into the twisted triangular female part 24 to thereby be started to rotate, the protrusions deform according to the shape of the twisted triangular female part 24, whereby the contact between the male parts and the twisted triangular female part 24 is ensured.

Moreover, as should be appreciated given the structure of the twisted triangular female part 24, the contact points 1 to 3 can be varied by modifying, with respect to the shown examples for Cases 1 and 2, the lengths and/or angles of the contacting edge (or surface) of the wedges. As such, a deep or shallow contact between the male and female parts can be achieved.

Additionally, although the shown aspects of this disclosure relate to all of the wedges of a particular case being of the same shape, another aspect (not shown) includes wedges of differing shapes. That is, another embodiment of this disclosure includes wedges, within a single implementation, of different contact edge angles (with respect to the base surface) and different contact edge lengths. In a further aspect, the widths (in the radial direction with respect to the rotational axis of the OPC drum 11) of the wedges can be varied, either between, embodiments altogether, or between individual wedges of a particular implementation, and the widths of either one or two of the three wedges can be varied.

Case 2 is shown in FIG. 2, which illustrates a similar ratchet-shape male part 23 to that of Case 1, but where the angle of the contact edge is varied with respect to the perpendicular with the base of the OPC drum 11. In particular, a side view of the wedges reveals the wedges each having an obtuse-triangular shape, as opposed to the right-triangular shape of Case 1.

In further embodiments, not shown, inner and outer profiles of the wedges, relative to the radial direction from the rotational axis of the OPC drum 11, can be varied in size and/or shape. That is, in the examples shown in Cases 1 and 2, the inner and outer profile shapes of the wedges are the same triangular shape—the same size and the same angles between edges. In the further embodiments, though, the triangular shape is modified to reflect different lengths of the various edges and/or different angles between the edges. As a results, the size and overall shape of the wedge can be different between the inner and outer profiles.

In the above Cases 1 and 2, the ratchet-shape male part includes three wedges so as to correspond to the three primary contacting surfaces/edges/points of a twisted triangular female part/recess. Other examples utilizing the twisted triangular female part/recess may utilize additional wedges so that multiple contact points can be made with the aforementioned three primary contact surfaces/edges. Such additional wedges can be displaced in the radial and circumferential directions, with respect to the concentric circles shown in the drawings, from the shown wedges.

Moreover, the Cases 1 and 2 depict wedges as having triangular side profiles and a rectangular or quadrilateral top and back profiles. These profile shapes are merely examples of one implementation. In other implementation, the wedges can include side profile shapes which are quadrilateral (or have more sides). When combined with the aforementioned aspects regarding differing inner and outer side profiles, the top and back profile shapes are modified to have different angles.

In such an implementation where the side profile shapes are quadrilateral, the contacting edge can be modified from a discrete contact as shown in FIGS. 1 and 2 to a contact surface, where the contacting edges and surfaces of the wedge follow a contour of the corresponding contact surface of the twisted triangular female part/recess. Also, protrusions described in the above Case 1 can be added for contact resilience and reliability.

The above-discussed examples relate to an engagement with a twisted triangular female part/recess. However, the discussed wedges can be adapted to engage other recesses, such as tapered recesses of another prism-type or polygonal shape.

The material of the male part is preferably the same or at least similar to that known in the art for prior male parts. However, the above-discussed protrusions can in one embodiment be made of a softer material, such as a soft polymer which can be dented so as to conform in whole or in part to a shape of a contacting edge of a female part. As such, the protrusions can be a separate material than that of the male part, and can be applied as a self-adhesive strip-like material, with an adhesive, or thermally applied.

In another aspect, the protrusions are made of the same material as that of the bulk of the male part and are formed at the same time as the bulk of the male part, e.g., by a plastic molding operation. As a result of the narrower dimensions, the protrusions are more susceptible to denting, allowing for the aforementioned benefit of protrusions conforming in whole or in part to the shape of the contacting edge of the female part.

In consideration of what has been described above, a material used to produce the male parts (also referred to as the projections) is preferably made from a crystalline resin. With a crystalline resin, in injection molding a male part using a die, since the resin flows well, good moldability can be provided. In addition, the resin is crystallized to be set even in the event that it is not cooled down to a glass transition point thereof, whereby an injection molded part can easily be removed from the die. Consequently, it is possible to increase the productivity largely. Additionally, the crystalline resin has superior heat resistance, solvent resistance, oil resistance, and grease resistance, as well as good friction and wear resistance and good slidability. Further, the crystalline resin is a preferable material to produce male parts from the viewpoint of rigidity and hardness.

It is possible to raise polyethylene, polypropylene, polyamide, polyacetal, polyethylene terephthalate, polybutylene terephthalate, methylpentene, polyphenylene sulfide, polyether ketone, polytetrafluoroethylene, and nylon as crystalline resins. Further, it is possible to use a combination of a resin or composite resin and a fabric material. It is preferable to use a polyacetal system resin among the candidate resins from the viewpoint of moldability. Further, a strength member (glass fiber, carbon fiber or a metallic pin) may be filled as a supporting interior member having a construction shown in the figures from the view point of enhanced strength.

It is also possible that the male parts can be brought into engagement with the female part smoothly by forming part or the whole of the male parts (also referred to as the protrusions) from a material having slidability (for example, a polyacetal containing Teflon).

### Second Embodiment

Hereinafter, a gear mechanism 15 according to a second embodiment will be described by reference to the drawings. It should be noted that in the first and second embodiments like reference numerals or characters denote the same or corresponding parts throughout the drawings when the numerals or characters coincide with each other. Further, in the specific embodiments, parts shown in the drawings are represented on a proper scale so that optimum ratios and measurements of the parts can be induced directly from the drawings. In other forms disclosed herein, when they are shown in the drawings, parts do not have to be drawn to scale.

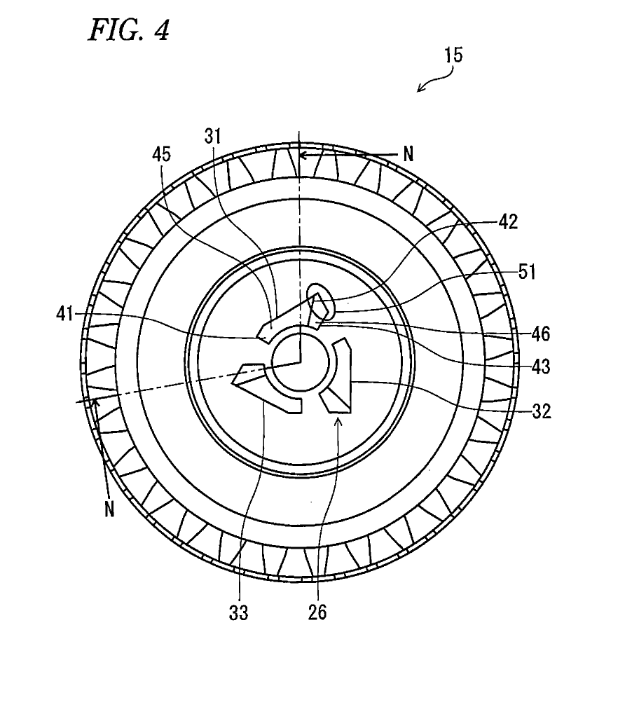

FIG. 4 is a plan view showing male parts 26 which are mounted on a gear mechanism 15. When mounted as shown in FIG. 4, the male parts 26 can be brought into engagement with a twisted triangular female part. Additionally, the gear mechanism 15 including the male parts 26 can be mounted in a rotating part such as an OPC drum 11. It should be noted that the female part does not have to be twisted.

As with the ratchet-shape male parts 22, 23 according to the first embodiment, the gear mechanism 15 according to this embodiment has first to third ratchets 31 to 33. However, they differ in shape from the ratchets according to the first embodiment.

Specifically, in the first to third ratchets 31 to 33, a rotational force receiving surface stands perpendicularly to an end face of the gear mechanism 15 as with the ratchets of the first embodiment. However, a back surface of the rotational force receiving surface is formed into a curved slope. In addition, in the first to third ratchets 31 to 33, an inner circumferential surface which faces a rotational shaft is formed into an arc-like shape which is curved about the rotational shaft.

Here, angles that will be described below are angles based on a 360° coordinate system. The tolerance of these radial and angular dimensions is allowed to fall within a range of ±4 to 6° while preferred shapes and arrangements shown in the description and drawings which will follow this are still maintained. However, a larger tolerance is allowed without departing from the scope of the disclosure herein. Similarly, although a tolerance of 1 mm is optimum, it is possible to change the tolerance.

In this embodiment, the male part 26 includes three ratchets 31 to 33 positioned regularly (periodically) in a circular fashion. With respect to a circle of 360°, a first ratchet 31 is provided with a first edge 41 aligned at 300° extending in a radial direction with respect to a rotation axis (an axial direction), a second edge 42 aligned at 12° extending in the radial direction, and a third edge 43 aligned at 29° extending in the radial direction.

The first edge 41 is formed by an inclined surface 45 which extends in a rotational direction from a bottom portion of the male part 26 to an end portion of the male part 26, that is, the second edge 42 which is situated at an apex of the male part 26. This inclined surface 45 may be a flat surface or a curved surface.

Additionally, this inclined surface is in contact with a top surface which forms the end portion of the male part 26, in a position of the second edge 42. The top surface 46 is formed into a flat surface, for example. The top surface 46 is in contact with a contact surface and a non-contact surface, which will be described later, in the position of the third edge 43.

An arcuate surface is formed as a surface which is surrounded by the non-contact surface, the top surface 46 and the inclined surface 45. The arcuate surface has an arc-like curved surface and extends in a direction along the rotational shaft (a shaft hole in the gear mechanism 15).

Additionally, the contact surface is formed by a wedge having a width of 17° and extends in a direction in which the contact surface faces an inner circumferential surface of a triangular recessed portion such as a twisted triangular female portion at least in the position of an edge thereof.

Namely, the ratchets are made to be brought into contact with the female part such as the twisted triangular female part not at a single point but via the edge (a contact edge indicated by a circle 51 in FIG. 4, in the embodiment) or the contact surface.

The slanted surface in this implementation has a radial wedge width of 60°+12° (72°). It should be appreciated that these radial wedge widths are exemplary. Tolerances of these radial and angular dimensions can be within ±4° to 6° while still remaining within the preferred shape and positioning of the ratchets. However, larger tolerances can be implemented without detracting from the scope of this disclosure.

The second ratchet 32 and the third ratchet 33 are structured in a fashion similar to the first ratchet 31, but positioned, respectively, 120° apart from one another. It should be appreciated that the number of ratchets and the particular placement, radial direction/width and size can be varied depending on the shape and form of female part.

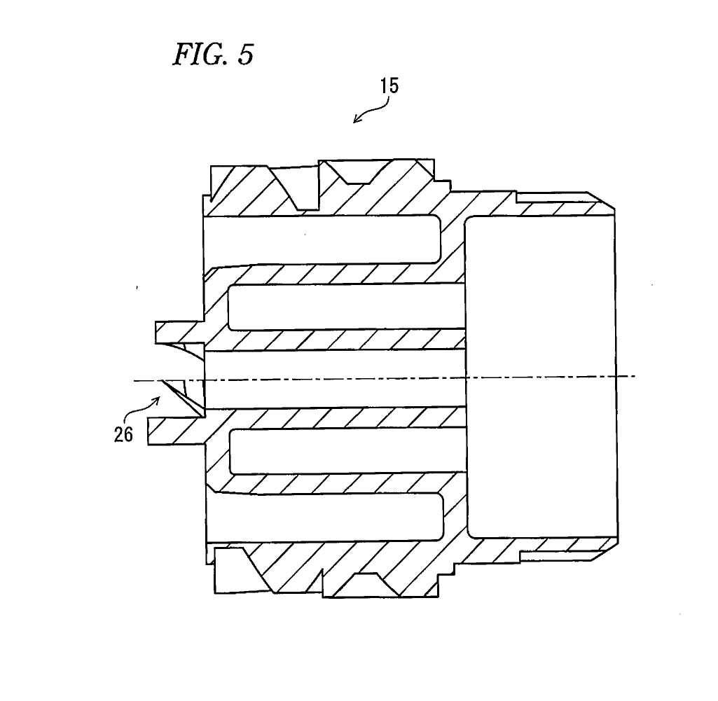

FIG. 5 is a sectional view of the gear mechanism 15 having the male part 26 shown in FIG. 4 taken along line N-N of FIG. 4. In FIG. 5, the slant of the slanted surface of the male part 26 is shown together with the internal structure of the gear mechanism 15.

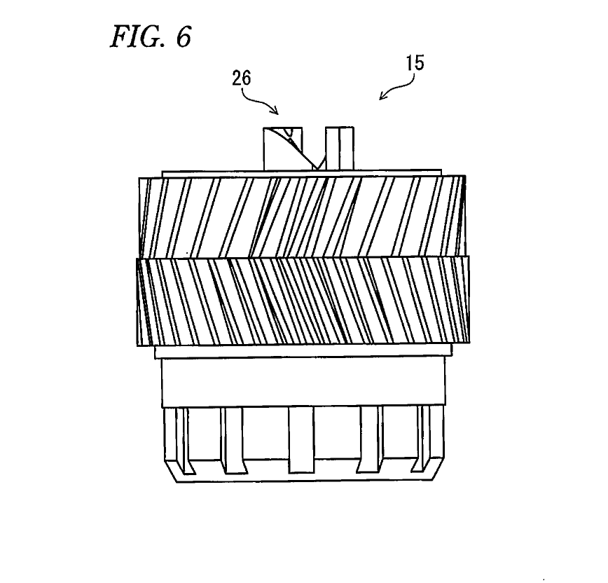

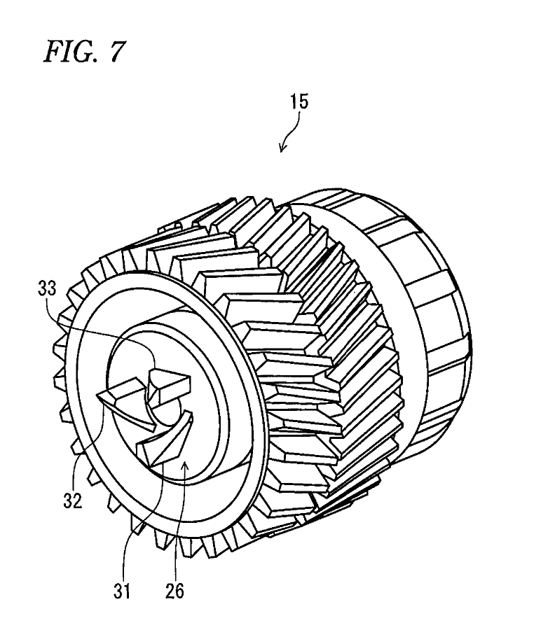

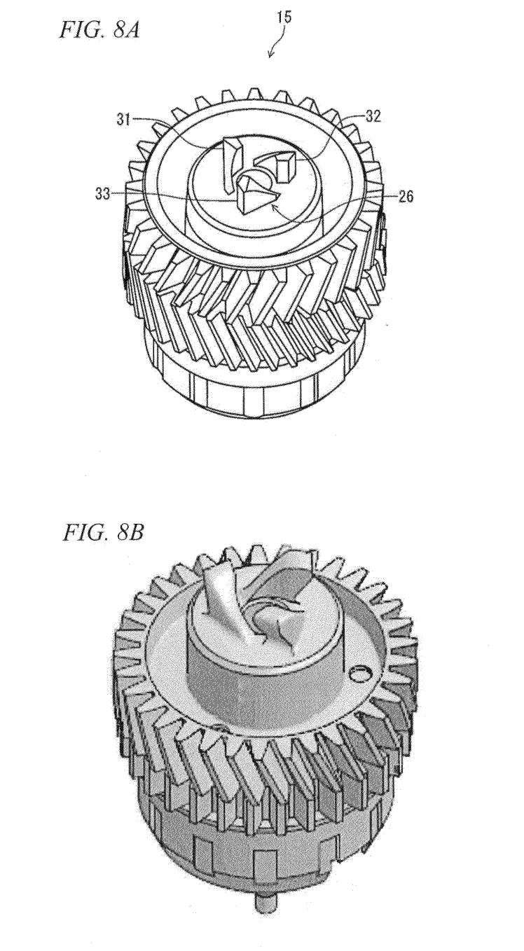

FIGS. 6 to 8 show a side view, a side perspective view and a top perspective view of the gear mechanism 15 having the male parts 26, respectively. By adopting the gear mechanism 15 having the male parts 26 described above, in an image forming apparatus according to the second embodiment, when a process cartridge 2 is mounted therein, the male parts 26 can easily be brought into engagement with the twisted triangular female part, and the deformation of a specific location of the female part can be prevented while a rotating part is rotating. Further, by configuring the male parts as the ratchets, when compared with a case where the male parts each have a hexagonal shape, the material needed to form the male parts can be reduced largely.

The ratchets of this embodiment can each be regarded as a plurality of wedges which are formed by a plurality of surfaces and a collection of edges defined between the surfaces. The shapes of the surfaces and the lengths of the edges between the wedges can be changed according to embodiments of the invention, and intersection points of the edges and the edges themselves can be formed into a curvilinear shape.

In this embodiment, while the male parts 26 are described as being brought into engagement with the twisted triangular female part, the invention is not limited thereto, and hence, the male parts can be brought into engagement with other recessed portions such as a tapered recessed portion, a recessed portion having a prism-like shape or a polygonal recessed shape.

The material used to produce the male parts or the gear mechanism is preferably made from a crystalline resin. With a crystalline resin, in injection molding a male part using a die, since the resin flows well, good moldability can be provided. In addition, the resin is crystallized to be set even in the event that it is not cooled down to a glass transition point thereof, whereby an injection molded part can easily be removed from the die. Consequently, it is possible to increase the productivity largely. Additionally, the crystalline resin has superior heat resistance, solvent resistance, oil resistance, and grease resistance, as well as good friction and wear resistance and good slidability. Further, the crystalline resin is a preferable material to produce male parts from the viewpoint of rigidity and hardness.

It is possible to raise polyethylene, polypropylene, polyamide, polyacetal, polyethylene terephthalate, polybutylene terephthalate, methylpentene, polyphenylene sulfide, polyether ketone, polytetrafluoroethylene, and nylon as crystalline resins. Further, it is possible to use a combination of a resin or composite resin and a fabric material. It is preferable to use a polyacetal system resin among the candidate resins from the viewpoint of moldability. Further, a strength member (glass fiber, carbon fiber or a metallic pin) may be filled as a supporting interior member having a construction shown in the figures from the view point of enhanced strength.

It is also possible that the male parts can be brought into engagement with the female part smoothly by forming part or the whole of the male parts (also referred to as the protrusions) from a material having slidability (for example, a polyacetal containing Teflon).

In addition, the reinforcement member such as the metallic pin may be used as the supporting interior member.

### INDUSTRIAL APPLICABILITY

According to the invention, in the rotating part used in the image forming apparatus, the shape of the engagement portion between the drive member and the driven member can be optimized, and hence, the invention is suitable for application to the image forming apparatus.

### DESCRIPTION OF REFERENCE NUMERALS

1 apparatus main body; 2 process cartridge; 3 charge roller; 4 developing roller; 5 restriction member; 6 transfer member; 7 cleaning blade; 8 casing; 10 photosensitive drum unit; 11 OPC drum; 12 lid member; 13 end portion member; 15, 90 gear mechanism; 20 rotating part; 22, 23 ratchet-shape male part; 24 twisted triangular female part; 26 male part; 31 first ratchet; 32 second ratchet; 33 third ratchet; 41 first edge; 42 second edge; 43 third edge; 45 inclined surface; 46 top surface; 91 male part

1. A rotating part for an image forming apparatus, comprising:
a drive member configured to transmit power; and
a driven member which is rotated by the drive member, wherein
either of the drive member and the driven member has a male part which is formed in the direction of a rotational shaft, wherein
the other of the drive member and the driven member has a female part which is formed in the direction of the rotational shaft and into which the male part is inserted, and wherein
the male part is a ratchet-shape male part configured to be inserted into the female part and in which when the drive member rotates in a first direction, the male part is brought into engagement with the female part to thereby transmit power from the drive member to the driven member, while when the drive member rotates in a second direction opposite to the first direction, the male part and the female part move away from each other in the direction of the rotational shaft to thereby transmit no power from the drive member to the driven member.

2. The rotating part according to claim 1, wherein
the female part is a twisted triangular female part in which a section normal to the rotational shaft has a triangular shape and the triangular shape of the section continuously rotates about the rotational shaft from a bottom portion to a top portion whereby a predetermined difference in angle about the rotational shaft is provided between a triangular shape which forms a section at the base portion and a triangle which forms a section at the top portion.

3. The rotating part according to claim 2, wherein
the ratchet-shape male part includes a plurality of wedges extending from a surface of a bottom surface.

4. The rotating part according to claim 3, wherein
a side profile of the wedges is triangular.

5. The rotating part according to claim 4, wherein
the side profile is right triangular.

6. The rotating part according to claim 4, wherein
the side profile is obtuse triangular.

7. The rotating part according to claim 3, wherein
a side profile of the wedges is quadrilateral.

8. The rotating part according to claim 7, wherein
the wedge has an inner side profile and an outer side profile which correspond to an interior radial position and an exterior radial position, respectively, of the rotating part, wherein
the inner side profile and the outer side profile have different shapes, and wherein
the inner side profile is larger than the outer side profile.

9. The rotating part according to claim 8, wherein
the wedges each includes a contact surface which extends between corresponding edges of the inner and outer side profiles thereof which have quadrilateral shapes, the contact surface configured to have a complementary contour to that of a corresponding contact surface of the twisted triangular female part.

10. The rotating part according to claim 3, wherein
a side profile from an outer radial view of the wedges differs from an inner radial view of the wedges, with respect to a radial direction extending from a rotation direction of the rotating part.

11. The rotating part according to claim 1, further comprising a cylindrical body including a photoconductor.

12. An imaging cartridge for an image forming apparatus comprising the rotating part according to claim 1.

13. An image forming apparatus comprising the imaging cartridge according to claim 12 and the twisted triangular female part as a drive member for driving and rotating the rotating part.

14. An image forming apparatus comprising:
a rotating part removable from the image forming apparatus, the rotating part including a twisted triangular female part; and
a drive transmission member including a ratchet-shape male part configured to be inserted into the twisted triangular female part to drive and rotate the rotating part.

15. The rotating part according to claim 1, wherein
the female part is a female part having a prism-like shape, and wherein
the male part comprises a plurality of ratchet-shape male parts configured to be inserted into the prism-shaped female part and each of the ratchet-shape male part has a rotational force receiving surface which is brought into contact with an inner circumferential surface of the female part.

16. The rotating part according to claim 15, wherein
in the ratchet-shape male parts, a back surface of the rotational force receiving surface is a curved slope.

17. The rotating part according to claim 15, wherein
in the ratchet-shape male parts, an inner circumferential surface which faces oppositely the rotational shaft is formed into an arc-like shape which is arcuate about the rotational shaft.
